(19) United States
(12) Patent Application Publication
(10) Pub. No.: US 2010/0245283 A1
(43) Pub. Date: Sep. 30, 2010

(54) CAPACITIVE TOUCH PANEL WITH CUSTOMIZABLE FUNCTION ICONS AND THE METHOD THEREOF

(75) Inventors: Shi-Hao LEE, Sinshih Township (TW); Yu-Wei Liu, Sinshih Township (TW)

Correspondence Address: DITTHAVONG MORI & STEINER, P.C., 918 Prince Street, Alexandria, VA, 22314, US

(73) Assignee: Sintek Photronic Corporation, Sinshih Township (TW)

(21) Appl. No.: 12/472,059

(22) Filed: May 26, 2009

(30) Foreign Application Priority Data
Mar. 30, 2009 (TW) 098110364

(51) Int. Cl. G06F 3/045

(52) U.S. Cl. 345/174

(57) ABSTRACT

A capacitive touch panel with customizable function icons and the method thereof are disclosed. The touch panel has a plurality of inductive electrode patterns arranged on a substrate regularly firstly. A plurality of functional icons are then defined on the touch panel. Each of the inductive electrode patterns is respectively connected to a control chip on a control circuit board via a wire. The control chip designates the plurality of inductive electrode patterns as a functional group to correspond to one of a plurality of functional icons, so as to execute the corresponding function. Whenever the position or the size of the functional icons needs to be altered, only the inductive electrode patterns that correspond to the functional icon need to be altered within the control chip to become effective immediately.

### FIELD OF THE INVENTION

The present invention relates to a touch panel, and more particularly to a capacitive touch panel with customizable function icons and method thereof.

### BACKGROUND OF THE INVENTION

Based on the fact of that the 3C products are rising and developing, continuously. The input devices such as keyboard or mouse of these consumer products are replaced by the touch panel gradually. The touch panel technology provides a friendly interface to allow a user may operate a computer or electronic products more convenient and easier than ever. Additionally, the applications of the touch panels are widely spread, the field of such devices includes but not limited to portable communication or information devices (such as personal digital assistant, PDA), financial/commercial system, hospital register system, monitoring and control system, information system and computer assisted instruction system, etc. The convenience of operation is upgrade owing to it's friendly operation interface.

The above mentioned application usually utilizes single-touch panel or writing pad as an input device. However, the single-touch panel or writing pad only can detect a single touch-point at one time. In other words, it merely can receive or process an identification position of the touch signal at each time. Referring to FIG. 8, it is a diagram of the single-touch panel of the prior art. The plurality of inductive electrode patterns 60 are formed on the glass substrate, and the inductive electrode patterns respectively are connected to a control chip 66 on a control circuit board 64 via a wire 62. While a user presses the touch panel, the control chip will detect the position of the pressing point to execute a corresponding function.

U.S. Pat. No. 4,233,522 has disclosed a capacitive touch panel comprising an array of touch sensitive switch cells. Each switch cell includes a first and a second pair of series connected capacitors energized by a common signal source, the array of switch cells being arranged so that the first pair of capacitors are connected in first groups of switch cells, such as rows, to a corresponding first plurality of signal detectors, and the second pair of capacitors are connected in second groups of switch cells, such as columns, to a corresponding second plurality of signal detectors, the junctions of each pair of capacitors of a single switch cell being selectively coupled to ground by the body or other touch capacitive means for actuating a selected switch cell.

WO Patent No. 2008108514 has disclosed a touch location detecting panel having a plurality of sensing areas arranged two-dimensionally. Each of the sensing areas includes a plurality of partitioned areas electrically isolated from each other, and the partitioned areas are respectively connected to separate channels of a circuit for detecting a user's touch on each of the partitioned areas.

U.S. Pat. No. 7,030,860 has disclosed a transparent, capacitive sensing system particularly well suited for input to electronic devices. The capacitive sensor can further be used as an input device for a graphical user interface, especially if overlaid on top of a display device like an LCD screen to sense finger position and contact area over the display.

In generally, an icons layer as a skin is coated with the touch screen. The known single-touch panel is that each inductive electrode pattern is corresponded to a functional icon. In other words, if the screen provides plurality of the functional icons for user, the amounts of the inductive electrode patterns are equal to amounts of the functional icons, the icons is mapped to an inductive electrode pattern. For instance, U.S. Pat. No. 7,460,893 has disclosed a portable electronic device including a first section having a first display on a first side of the first; and a second section pivotably connected to the first section. The second section includes a second display on a first side of the second section. Wherein the first display has plurality of functional icons, the icons are pressed to execute the corresponding functional.

However, the configuration such an inductive electrode pattern is corresponded to an icon, respectively. While the position or size of the functional icons is altered, the touch panel will need to be redesigned substantially, for example, to redesign mask or to rearrange the layout. As aforementioned above, the manufacture procedure is not flexible, and the cost is high comparatively.

Due to the aforementioned weakness, a novel and advanced programmable touch system is provided, so that to overcome the drawback of the prior art. The capacitive touch panel can quickly designate the inductive electrode patterns to correspond to the position of an icon based on the demand of the different customers.

### SUMMARY OF THE INVENTION

In view of foregoing, the manufacturing procedure must be amended substantially to alter the position or size of the functional icons, which induces resource to redesign and test and accordingly raises the manufacturing cost. For this reason, the present invention discloses a capacitive touch panel with customizable function icons.

It is one object of the present invention to provide a capacitive touch panel with customizable function icons. Whenever the arrangement of the functional icons needs to be altered, the present invention does not have to alter the inductive electrode patterns in order to fit the new functional icons.

It is another object of the present invention to provide a method of forming the capacitive touch panel with customizable function icons. Whenever the arrangement of the functional icons needs to be altered, the present invention does not have to alter the inductive electrode patterns in order to fit the new functional icons.

In order to achieve the above object, the present invention discloses a capacitive touch panel with customizable function icons, comprising: a substrate; a plurality of inductive electrode patterns formed on the substrate, each of the inductive electrode patterns being respectively connected to a control chip on a control circuit board via a wire; wherein a plurality of the functional icons are defined on the touch panel, and the control chip designates some of the inductive electrode patterns as a functional group to correspond to one of the functional icons.

In order to achieve the above another object, the present invention discloses a method of customizing functional icons of a capacitive touch panel, comprising: (a) forming a plurality of inductive electrode patterns on a substrate; (b) defining a plurality of functional icons on the touch panel; (c) allocating the plurality of inductive electrodes patterns as a functional group via a control chip to correspond to one of the functional icons; (d) repeating the step (c), until all of the functional icons on the touch panel are defined.

The control chip comprises a programmable program for setting corresponding inductive electrode patterns for the functional icons, so as to satisfy the demand of different users.

The plurality of the inductive electrode patterns are arranged irregularly on the substrate.

Each area of the inductive electrode patterns is equal to one another but smaller than the area of the functional icon, so as to designate a plurality of inductive electrode patterns to correspond to a functional icon.

Each area of the inductive electrode patterns is not less than 3×3 mm².

Some of the inductive electrode patterns are turned off by the control chip, such that only the other functional icons are presented on the operation screen.

A plurality of functional icons are arranged differently in the screen of the touch panel for different operation pages.

According to above structure of the present invention, the plurality of inductive electrodes patterns are designated as a functional group via a control chip to correspond to one of the functional icons, while a user presses any one of the inductive electrode patterns of the group, the functional icon will be active. Therefore, if the arrangement of the functional icons must be altered, the single one step of the present invention is to amend the program of the control chip to be adapted to correspond to the functional icons. The present invention can avoid redesigning and remanufacturing inductive electrode patterns of the touch panel and can avoid spending long time to redesign and test, and it is more flexible to design, and the manufacturing cost is lower comparatively.

One advantage of the present invention is that the touch panel can avoid the need of redesign if the positions of the functional icons are altered.

Another advantage of the present invention is that the inductive electrode patterns can be controlled to be shown or remained by the control chip.

Still another advantage of the present invention is that spending long time to redesign and test can be avoided, and the manufacturing cost is lower comparatively.

A detailed description is given in the following embodiments and with reference to the accompanying drawings and claims.

### BRIEF DESCRIPTION OF THE DRAWINGS

FIG. 1 is a diagram of the arrangement of the inductive electrode patterns.

FIG. 2 is a diagram of the arrangement of the icons of an embodiment.

FIG. 3 is a diagram of the arrangement of the inductive electrode patterns corresponding to the icons of the FIG. 2.

FIG. 4 is a diagram of the arrangement of the icons of another embodiment.

FIG. 5 is a diagram of the arrangement of the inductive electrode patterns corresponding to the icons of the FIG. 4.

FIG. 6 is a diagram of the arrangement of the icons of another embodiment.

FIG. 7 is a diagram of the arrangement of the inductive electrode patterns corresponding to the icons of the FIG. 6.

FIG. 8 is a diagram of the single-touch panel of the prior art.

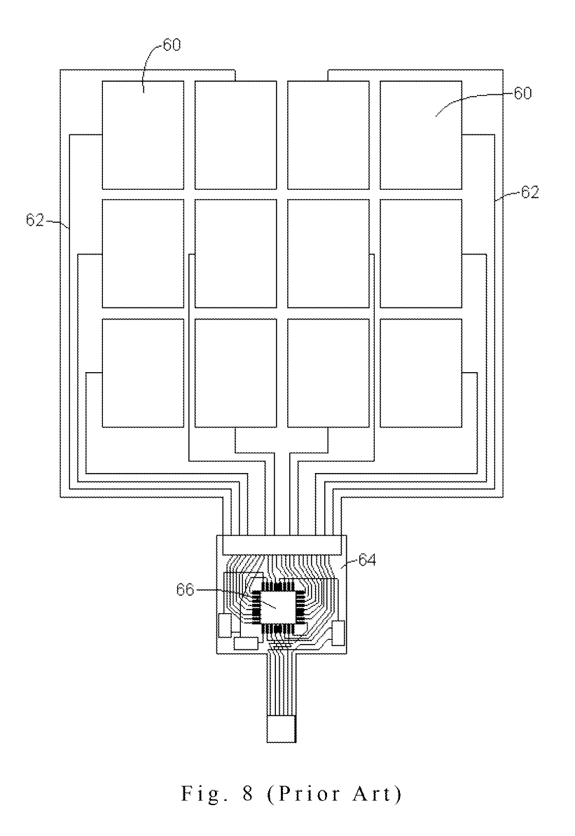

### DETAILED DESCRIPTION OF THE PREFERRED EMBODIMENT

The invention hereinafter will be described in greater detail with preferred embodiments of the invention and accompanying illustrations. Nevertheless, it should be recognized that the preferred embodiments of the invention are not provided to limit the invention but to illustrate it. The present invention can be practiced not only in the preferred embodiments herein mentioned, but also in a wide range of other embodiments besides those explicitly described. Further, the scope of the present invention is expressly not limited to any particular embodiments except what is specified in the appended Claims.

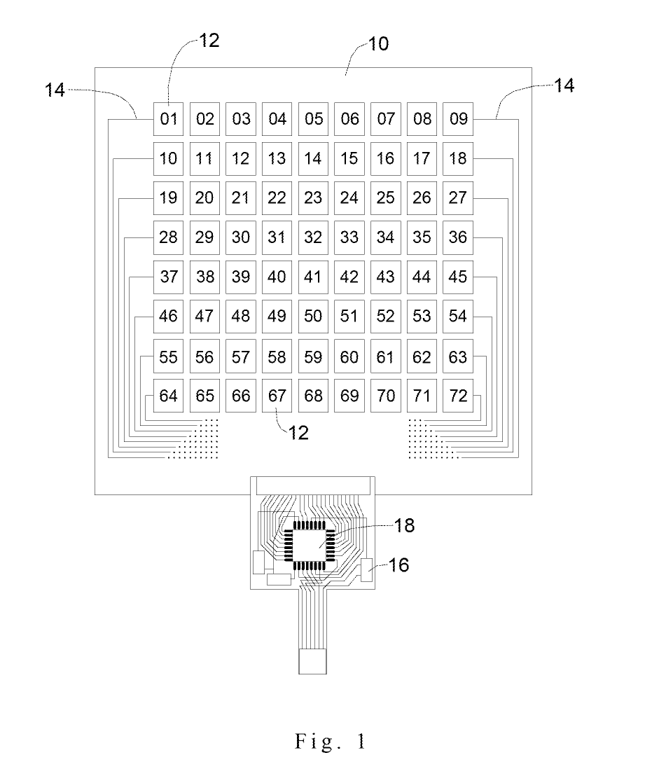

Referring to FIG. 1, the plurality of inductive electrode patterns 12 are regularly formed on substrate 10. For example, in this embodiment the plurality of inductive electrode patterns 12 are arranged in an array closely. Each inductive electrode patterns 12 is connected to a wire 14 and subsequently connected to a control chip 18 on a control circuit board 16 via the wire 14. Each area of the inductive electrode patterns 12 is substantially equal to one another but smaller than the area of the functional icon. In a preferred embodiment, each area of the inductive electrode patterns 12 is not less than 3×3 mm². In order to present in a concise manner, merely part of the wires 14 are shown in the drawing. The wires 14 can be made of metal material or indium tin oxide (ITO). One end of the wire 14 is connected to the inductive electrode patterns 12 and the other end of the wire 14 is connected to the control chip 18 on the control circuit board 16 which can be made of flexible printed circuit (FPC) or printed circuit board (PCB). In addition, the control chip comprises a programmable program for setting corresponding inductive electrode patterns for the functional icons, so as to satisfy the demand of different users.

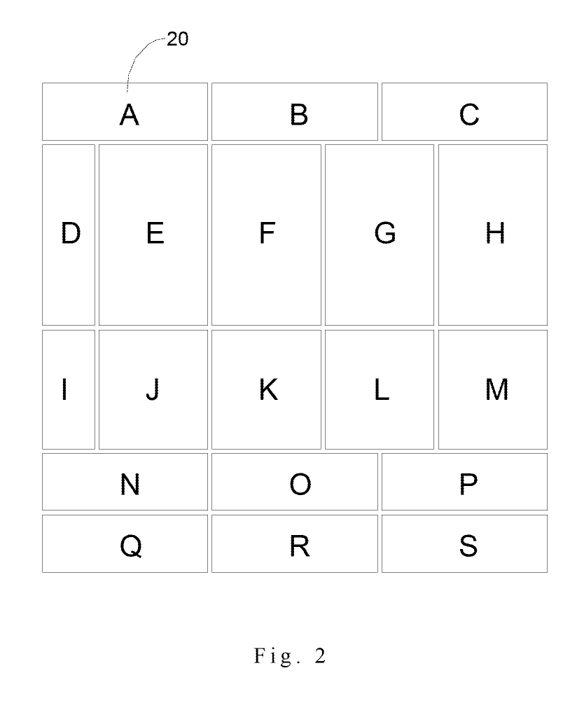

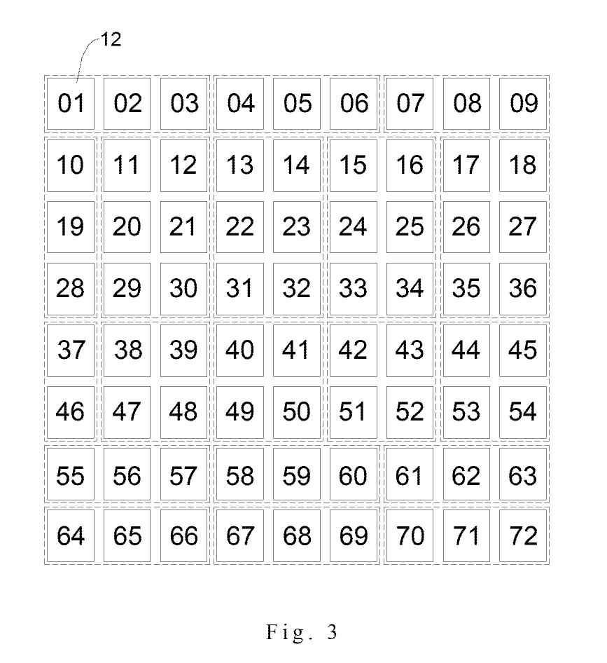

Referring to FIG. 2 and FIG. 3, one embodiment of the present invention is illustrated. The screen has a plurality of functional icons 20 (icon A˜icon S) which are arranged irregularly. In this embodiment, the icon A is composed of a 1×3 inductive electrode pattern, and the icon E is composed of a 2×3 inductive electrode pattern. The touch panel of the present invention can be utilized to easily complete setting the corresponding functions for the functional icons by means of only designating the plurality of inductive electrodes patterns 12 as a functional group via a control chip 18 to correspond to one of the functional icons 20. While a user presses any of inductive electrode patterns 12 in the functional group, the specific functional icon 20 will be activated. Table 1 lists all of the inductive electrode patterns which the respective functional icons A˜S correspond to. For example, the icon A is composed of the inductive electrode patterns 01, 02 and 03, and the icon B is composed of the inductive electrode patterns 04, 05 and 06, and so forth. While any of the inductive electrode patterns 01, 02 and 03 is pressed, the control chip connected to the inductive electrode patterns 01, 02 and 03 will detect the pressing signal and thereby executing a corresponding action. Similarly, while any of the inductive electrode patterns 04, 05 and 06 is pressed, the control chip 18 will detect the pressing signal and thereby executing an action defined by icon B.

TABLE 1

| | Inductive | | Inductive | | Inductive |
|---|---|---|---|---|---|
| | Electrode | | Electrode | | Electrode |
| Icon | Patterns | Icon | Patterns | Icon | Patterns |
| A | 01, 02, 03 | B | 04, 05, 06 | C | 07, 08, 09 |
| D | 10, 19, 28 | E | 11, 12, 20, 21, | F | 13, 14, 22, 23, |
| | | | 29, 30 | | 31, 32 |
| G | 15, 16, 24, 25, | H | 17, 18, 26, 27, | I | 37, 46 |
| | 33, 34 | | 35, 36 | | |
| J | 38, 39, 47, 48 | K | 40, 41, 49, 50 | L | 42, 43, 51, 52, |
| M | 44, 45, 53, 54 | N | 55, 56, 57 | O | 58, 59, 60 |
| P | 61, 62, 63 | Q | 64, 65, 66 | R | 67, 68, 69 |
| S | 70, 71, 72 | | | | |

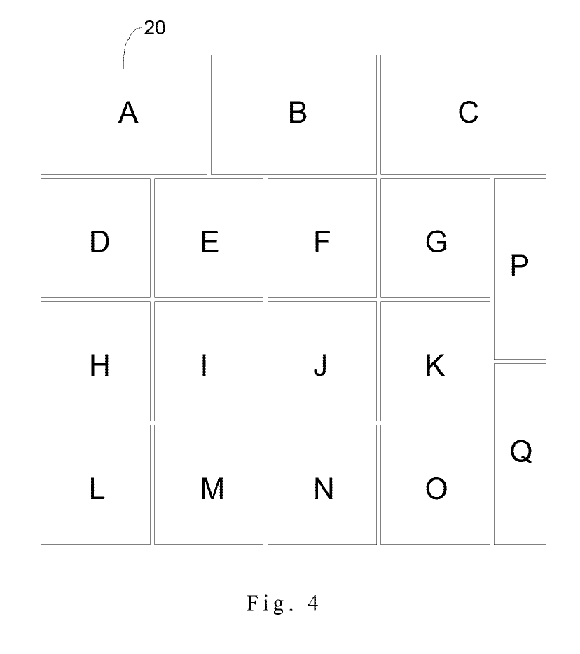

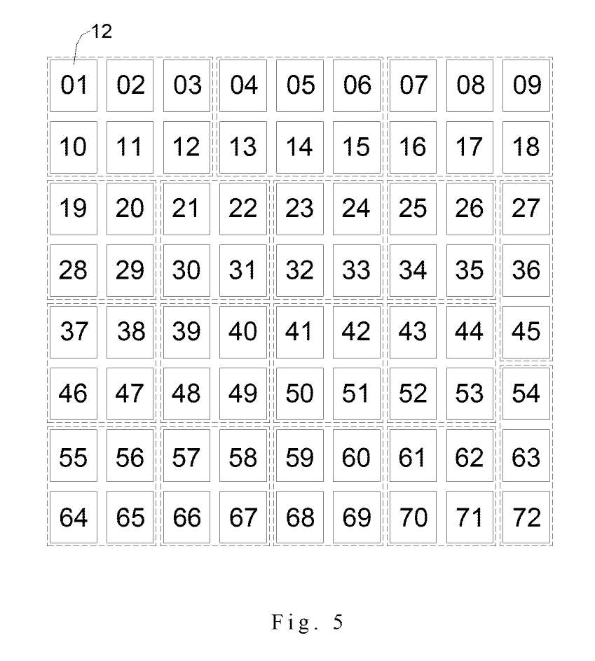

Referring to FIG. 4 and FIG. 5, another embodiment of the present invention is illustrated. The functional icons are arranged in another pattern. Table 2 lists the inductive electrode patterns which the respective functional icons A˜Q correspond to.

TABLE 2

| | Inductive | | Inductive | | Inductive |
|---|---|---|---|---|---|
| | Electrode | | Electrode | | Electrode |
| Icon | Patterns | Icon | Patterns | Icon | Patterns |
| A | 01, 02, 03, 10, | B | 04, 05, 06, 13, | C | 07, 08, 09, 16, |
| | 11, 12 | | 14, 15 | | 17, 18 |
| D | 19, 20, 28, 29 | E | 21, 22, 30, 31 | F | 23, 24, 32, 33 |
| G | 25, 26, 34, 35 | H | 37, 38, 46, 47 | I | 39, 40, 48, 49, |
| J | 41, 42, 50, 51 | K | 43, 44, 52, 53 | L | 55, 56, 64, 65 |
| M | 57, 58, 66, 67 | N | 59, 60, 68, 69 | O | 61, 62, 70, 71 |
| P | 27, 36, 45 | Q | 54, 63, 72 | | |

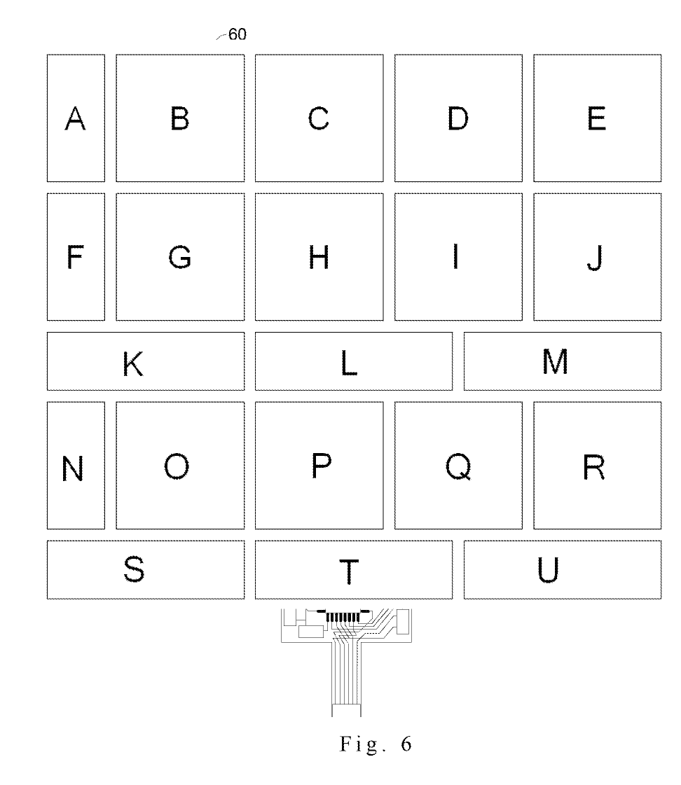

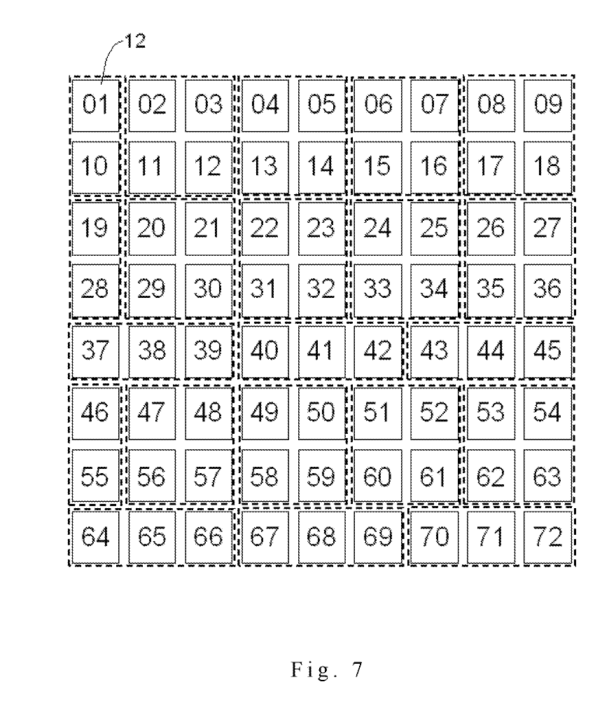

Referring to FIG. 6 and FIG. 7, still another embodiment of the present invention is illustrated. The functional icons are arranged in still another pattern. Table lists the inductive electrode patterns which the respective functional icons A˜U correspond to.

TABLE 3

| | Inductive | | Inductive | | Inductive |
|---|---|---|---|---|---|
| | Electrode | | Electrode | | Electrode |
| Icon | Patterns | Icon | Patterns | Icon | Patterns |
| A | 01, 10 | B | 02, 03, 11, 12 | C | 04, 05, 13, 14 |
| D | 06, 07, 15, 16 | E | 08, 09, 17, 18 | F | 19, 18 |
| G | 20, 21, 29, 30 | H | 22, 23, 31, 32 | I | 24, 25, 33, 34 |
| J | 26, 27, 35, 36 | K | 37, 38, 39 | L | 40, 41, 42 |
| M | 43, 44, 45 | N | 46, 55 | O | 47, 48, 56, 57 |
| P | 49, 50, 58, 59 | Q | 51, 52, 60, 61 | R | 53, 54, 62, 63 |
| S | 64, 65, 66 | T | 67, 68, 69 | U | 70, 71, 72 |

From the aforementioned embodiments, it can be appreciated that the present invention enables the positions of the functional icons to be altered and further enables the patterns of the functional icons to be altered. The functional icon A is taken as an example below to illustrate the present invention. In the first embodiment, the functional icon A is composed of a 1×3 inductive electrode pattern. In the second embodiment, it is composed of a 2×3 inductive electrode pattern. In the third embodiment, it is composed of a 2×1 inductive electrode pattern. The shape composed by the inductive electrode patterns of the present invention is not limited to the rectangle shape, and therefore may be any other irregular shapes to implement the present invention. In addition, the shape of said functional icons is different one to another.

Some of the inductive electrode patterns 12 can be turned off partially. For example, areas A, B, C, P and Q in the FIG. 4 are turned off by the control chip 18, such that only the others functional icons are shown and remained on the screen. In general, the screen of the touch panel will change the pages automatically based on the user's operation to provide the interface for the user to instruct different actions such as selection or confirmation. Therefore, such control manner of turning off the inductive electrode patterns partially can be applied to the touch screen to change operation pages automatically, such that the functional icons 20 can be arranged differently for the different operation pages.

From the foregoing, the present invention forms a plurality of regularly and closely arranged inductive electrode patterns on a substrate firstly, and then defines a plurality of functional icons on a screen. Each of the inductive electrode patterns is subsequently connected to a control chip. The present invention merely has to alter the settings in the control chip to change the inductive electrode patterns which the respective functional icons correspond to, so as to satisfy the demand for alternative arrangement of the functional icons. The present invention does not have to alter the manufacturing processes of the touch panel or the control circuit board and therefore has higher design flexibility than any current products in the world.

While the embodiments of the present invention disclosed herein are presently considered to be preferred embodiments, various changes and modifications can be made without departing from the spirit and scope of the present invention. The scope of the invention is indicated in the appended claims, and all changes that come within the meaning and range of equivalents are intended to be embraced therein.

What is claimed is:

1. A capacitive touch panel with customizable function icons, comprising:
a substrate;
a plurality of inductive electrode patterns formed on said substrate, each of said inductive electrode patterns being respectively connected to a control chip on a control circuit board via a wire;
a plurality of functional icons defined on said touch panel, wherein said control chip designates some of said inductive electrode patterns as a functional group to correspond to one of said plurality of functional icons.

2. The touch panel as claimed in claim 1, wherein said control chip comprises a programmable program for setting corresponding said functional group for said functional icons.

3. The touch panel as claimed in claim 1, wherein the material of said wire comprises metal material or indium tin oxide (ITO).

4. The touch panel as claimed in claim 1, wherein the material of said control circuit board comprises flexible printed circuit (FPC) or printed circuit board (PCB).

5. The touch panel as claimed in claim 1, wherein said plurality of functional icons are arranged irregularly.

6. The touch panel as claimed in claim 1, wherein a shape of said functional icons is different to one another.

7. The touch panel as claimed in claim 1, wherein each area of said inductive electrode patterns is not less than 3×3 mm².

8. The touch panel as claimed in claim 1, wherein each area of said inductive electrode patterns is equal to one another but smaller than an area of said functional icons.

9. The touch panel as claimed in claim 1, wherein some of said inductive electrode patterns are turned off by said control chip.

10. The touch panel as claimed in claim 9, wherein said functional icons are arranged differently in a screen of said touch panel for different operation pages.

11. The touch panel as claimed in claim 1, wherein a shape composed by said inductive electrode patterns comprises irregular shapes.

12. A method of customizing functional icons of a capacitive touch panel, comprising:
(a) providing a plurality of inductive electrode patterns on a substrate;
(b) defining a plurality of functional icons on said touch panel;
(c) allocating said plurality of inductive electrodes patterns as a functional group via a control chip on a control board to correspond to one of said plurality of functional icons;
(d) repeating said step (c), until all of said plurality of functional icons on said touch panel are defined.

13. The method as claimed in claim 12, wherein said control chip comprises a programmable program for setting corresponding said functional group for said functional icons.

14. The method as claimed in claim 12, wherein the material of said control circuit board comprises flexible printed circuit (FPC) or printed circuit board (PCB).

15. The method as claimed in claim 12, wherein said plurality of functional icons are arranged irregularly.

16. The method as claimed in claim 12, wherein a shape of said functional icons is different to one another.

17. The method as claimed in claim 12, wherein each area of said inductive electrode patterns is not less than 3×3 mm².

18. The method as claimed in claim 12, wherein each area of said inductive electrode patterns is equal to one another but smaller than an area of said functional icons.

19. The method as claimed in claim 12, wherein some of said inductive electrode patterns are turned off by said control chip.

20. The method as claimed in claim 19, wherein said functional icons are arranged differently in a screen of said touch panel for different operation pages.
